(19) United States
(12) Patent Application Publication
(10) Pub. No.: US 2017/0069964 A1
(43) Pub. Date: Mar. 9, 2017

(54) ANTENNA SYSTEM HAVING AN AUTOMATICALLY ADJUSTABLE DIRECTIONAL ANTENNA STRUCTURE AND METHOD FOR AUTOMATICALLY ADJUSTING A DIRECTIONAL ANTENNA STRUCTURE

(71) Applicant: GETAC TECHNOLOGY CORPORATION, HSINCHU COUNTY (TW)

(72) Inventor: Hong-Tu CHEN, Taoyuan County (TW)

(21) Appl. No.: 14/845,611

(22) Filed: Sep. 4, 2015

(51) Int. Cl. H01Q 3/04

(52) U.S. Cl. CPC H01Q 3/04

(57) ABSTRACT

An antenna system having an automatically adjustable directional antenna structure and a method for automatically adjusting a direction antenna structure are disclosed. The method includes receiving a first radiation signal, delaying the first radiation signal to obtain a first delay signal, receiving a second radiation signal, delaying the second radiation signal to obtain a second delay signal, combining the first delay signal and the second radiation signal to obtain a first combined signal, combining the first radiation signal and the second delay signal to obtain a second combined signal, detecting the power of the first combined signal to output a first amplitude, detecting the power of the second combined signal to output a second amplitude, and rotating a substrate based on the first amplitude and the second amplitude, so that a normal direction of the substrate is rotated and substantially aimed at an object.

### BACKGROUND

Technical Field

The instant disclosure relates to a directional antenna structure, and particularly relates to a method for automatically adjusting a directional antenna and an antenna system having an automatically adjustable directional antenna.

Related Art

As the blooming of communication technologies, electronic device, e.g., tablet computers, notebook computers, mobile phones, and multimedia players, are popular in nowadays life. To satisfy users' requirements, the electronic device may have a wireless communication function. The electronic devices utilize antennas to send or receive wireless signals among each other. For some electronic devices, the user has to aim the antenna of the electronic device at a communication target so that the electronic device can receive the wireless signal from the communication target.

For example, when a user tends to use a notebook computer to receive the Wi-Fi signal generated from a Wi-Fi router, the user would have to manually adjust both the orientation and the angle of the antenna of the Wi-Fi router. That is, the user has to fix the azimuth angle of the antenna firstly until the intensity of the Wi-Fi signal received by the notebook computer is enhanced, and then the user has to fine tune the elevation angle of the antenna and determines if the notebook computer receives a Wi-Fi signal having a greatest intensity. The user has to repeatedly adjust the orientation and the angle of the antenna of the Wi-Fi router until the notebook computer can continuously receive workable Wi-Fi signals (i.e., Wi-Fi signals having intensities strong enough to enable the communication between the router and the notebook computer). Alternatively, if a user tends to use an antenna to receive satellite signals for watching satellite programs, the user may have to repeatedly adjust the orientation and the elevation angle of the antenna until the antenna can continuously receive workable satellite signals for playing satellite programs.

However, existing electronic devices are devoid of mechanisms for detecting the incidence direction of the signals during performing wireless communication. In other words, the electronic device cannot aim at its communication target automatically, and the user has to adjust the orientation of the antenna of the electronic device manually, resulting in the inconvenience for the user.

### SUMMARY

In one embodiment, a method for automatically adjusting a directional antenna structure is disclosed. The method comprises receiving a first radiation signal via a first antenna, delaying the first radiation signal to obtain a first delay signal, receiving a second radiation signal via a second antenna, delaying the second radiation signal to obtain a second delay signal, combining the first delay signal and the second radiation signal to obtain a first combined signal, combining the first radiation signal and the second delay signal to obtain a second combined signal, detecting the power of the first combined signal to output a first amplitude, detecting the power of the second combined signal to output a second amplitude, and rotating a substrate based on the first amplitude and the second amplitude, so that a normal direction of the substrate is rotated and substantially aimed at an object.

In one embodiment, an antenna system having an automatically adjustable directional antenna structure is provided. The antenna system comprises a substrate, a first antenna, a second antenna, a rotating mechanism, a first delay line, a second delay line, a first division module, a power detecting module, and a control module. The first antenna and the second antenna are assembled on the substrate. The rotating mechanism is coupled to the substrate. The first delay line is coupled to the first antenna. The second delay line is coupled to the second antenna. The control module is coupled to the rotating mechanism and the first division module. The first antenna is provided for receiving a first radiation signal. The second antenna is provided for receiving a second radiation signal. The first delay line is provided for delaying the first radiation signal to obtain a first delay signal. The second delay line is provided for delaying the second radiation signal to obtain a second delay signal. The first division module is provided for combining the first delay signal and the second radiation signal to obtain a first combined signal and combining the first radiation signal and the second delay signal to obtain a second combined signal. The power detecting module is provided for detecting the power of the first combined signal to output a first amplitude and detecting the power of the second combined signal to output a second amplitude. The control module is provided for controlling the rotating mechanism based on the first amplitude and the second amplitude so as to rotate the normal direction of the substrate to substantially aim at a flying object.

Based on the above, the direction of the directional antenna structure is adjusted by the control module of the antenna system, so that the directional antenna structure can trace the flying object or the communication target automatically. Because the antenna of the directional antenna structure can be maintained in a workable receiving state, the user does not have to adjust the antenna in a repeated and complicated manner.

### BRIEF DESCRIPTION OF THE DRAWINGS

The disclosure will become more fully understood from the detailed description given herein below for illustration only, and thus not limitative of the disclosure, wherein:

FIG. 1 illustrates a top view of an antenna system having an automatically adjustable directional antenna structure according to a first embodiment of the instant disclosure;

FIG. 2 illustrates a side view of the antenna system according to the first embodiment of the instant disclosure;

FIG. 3 illustrates a circuit block diagram of the first embodiment of the antenna system of FIGS. 1 and 2;

FIG. 4 illustrates a circuit block diagram of an embodiment of the power detecting module and the control module of the first embodiment of the antenna system shown in FIG. 3;

FIG. 5 illustrates a circuit block diagram of another embodiment of a control module of the first embodiment of the antenna system;

FIG. 6 illustrates a circuit block diagram of the second embodiment of the antenna system of FIGS. 1 and 2;

FIG. 7 illustrates a circuit block diagram of the third embodiment of the antenna system of FIGS. 1 and 2;

FIG. 8 illustrates a top view of an antenna system having an automatically adjustable directional antenna structure according to a second embodiment of the instant disclosure;

FIG. 9 illustrates a side view of the antenna system according to the second embodiment of the instant disclosure;

FIG. 10 illustrates a circuit block diagram of one embodiment of the antenna system of FIGS. 8 and 9;

FIG. 11 illustrates a circuit block diagram of an embodiment of the power detecting module and the control module of the second embodiment of the antenna system;

FIG. 12 illustrates a flowchart of a method for automatically adjusting a directional antenna structure according to a third embodiment of the instant disclosure;

FIG. 13 illustrates a flowchart of an embodiment of the method of the third embodiment; and

FIG. 14 illustrates a flowchart of a method for automatically adjusting a directional antenna structure according to a fourth embodiment of the instant disclosure.

### DETAILED DESCRIPTION

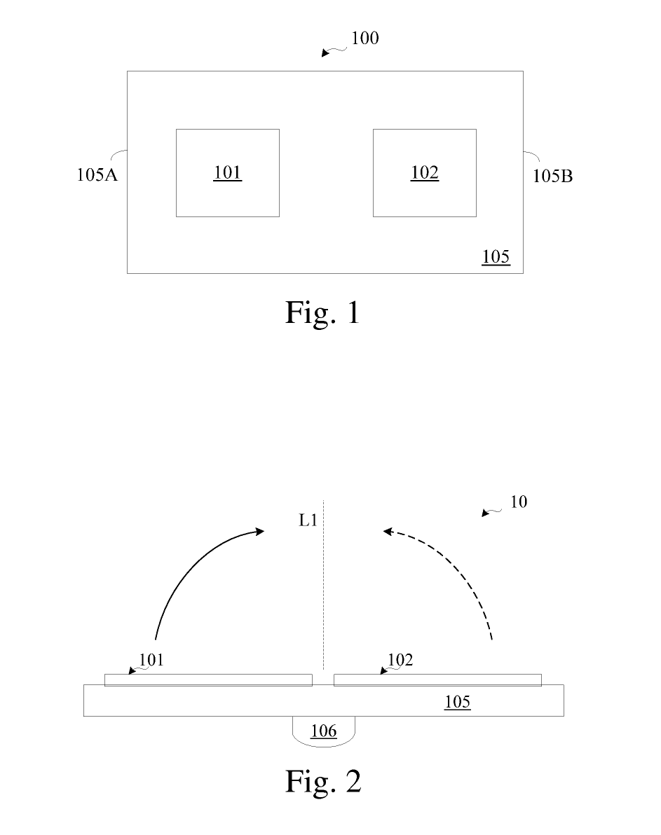

FIG. 1 and FIG. 2 illustrate respectively a top view and a side view of an antenna system 10 having an automatically adjustable directional antenna structure 100 according to a first embodiment of the instant disclosure. Please refer to FIG. 1 and FIG. 2, the antenna system 10 comprises a directional antenna structure 100 and a rotating mechanism 106. The directional antenna structure 100 comprises a first antenna 101, a second antenna 102, and a substrate 105. As shown in FIG. 1 and FIG. 2, the substrate 105 has a first surface and a second surface, the first antenna 101 and the second antenna 102 are disposed on the first surface of the substrate 105, and the rotating mechanism 106 is connected to the second surface of the substrate 105. The normal direction L1 of the substrate 105 may be changed along with the rotation of the rotating mechanism 106. Since both the first antenna 101 and the second antenna 102 are flatly disposed on the substrate 105, the normal direction L1 of the first antenna 101 and that of the second antenna 102 are the same as the normal direction L1 of the substrate 105, and the orientation of the normal direction L1 of the first antenna 101 and that of the second antenna 102 may be changed along with the rotation of the rotating mechanism 106.

In some embodiments, the substrate 105 has a first side 105A and a second side 105B; specifically, the first antenna 101 is close to the first side 105A while the second antenna 102 is close to the second side 105B. However, embodiments are not thus limited thereto. Alternatively, the first antenna 101 may be close to the second side 105B while the second antenna 102 may be close to the first side 105A. In some embodiments, the first antenna 101 and the second antenna 102 may be made of conductive materials (e.g., but not limited to, copper, silver, iron, alumina, or alloys of two or more of the aforementioned metals) and disposed on the substrate 105. Alternatively, the first antenna 101 and the second antenna 102 may be traces of a printed circuit board (PCB), and the PCB is disposed on the substrate 105

In some embodiments, the directional antenna structure 100 may be assembled to an electronic device (not shown). The directional antenna structure 100 may receive radio frequency signals through the first antenna 101 and the second antenna 102 so as to communicate with other electronic devices having wireless communication function (hereinafter, called “communication target”). The substrate 105 may a portion of the housing of the electronic device, and the rotating mechanism 106 may be assembled in the electronic device. The directional antenna structure 100 may be aimed at the communication target automatically by the rotating mechanism 106 with a mechanism to be described, i.e., the normal direction L1 of the substrate 101 of the directional antenna structure 100 is aimed at the communication target. In some embodiments, the rotating mechanism 106 may be implemented by a pivot shaft.

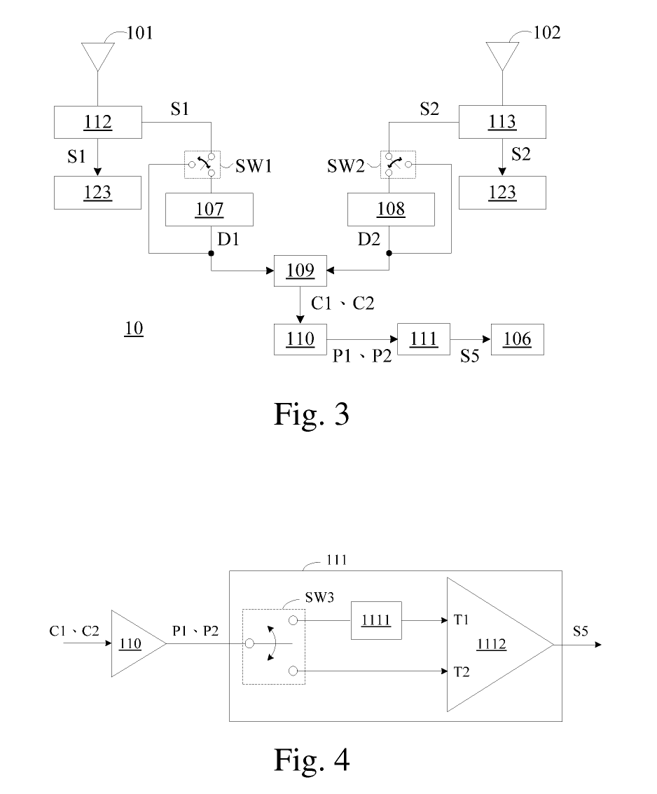

FIG. 3 illustrates a circuit block diagram of the first embodiment of the antenna system 10 of FIG. 1 and FIG. 2. Please refer to FIG. 3, the antenna system 10 comprises the first antenna 101, the second antenna 102, a first delay line 107, a second delay line 108, a first division module 109, a power detecting module 110, and a control module 111. (The substrate 105 is not shown in FIG. 3,)

In some embodiments, the first delay line 107, the second delay line 108, the first division module 109, the power detecting module 110, and the control module 111 may be integrated into an application-specific integrated circuit (ASIC). The designer of the antenna system 10 may assemble the ASIC to the substrate 105 and connect the input/output pins to the first antenna 101, the second antenna 1023, and the rotating mechanism 106.

As shown in FIG. 3, the first delay line 107 is coupled between the first antenna 101 and the first division module 109, and the second delay line 108 is coupled between the second antenna 102 and the first division module 109. The first division module 109, the power detecting module 110, the control module 111, and the rotating mechanism 106 are series-connected in a sequential manner.

The first antenna 101 receives a first radiation signal S1. The first delay line 107 is coupled to the first antenna 101 to receive the first radiation signal S1. The first delay line 107 delays the first radiation signal S1 to obtain a first delay signal D1. The second antenna 102 receives a second radiation signal S2. The second delay line 108 is coupled to the second antenna 102 to receive the second radiation signal S2. The second delay line 108 delays the second radiation signal S2 to obtain a second delay signal D2.

In some embodiments, the antenna system 10 further comprises a first coupling circuit 112 and a second coupling circuit 113. The first coupling circuit 112 is coupled between the first antenna 101 and the first delay line 107, and the first coupling circuit 112 is coupled between the first antenna 101 and the first division module 109. The second coupling circuit 113 is coupled between the second antenna 102 and the second delay line 108, and the second coupling circuit 113 is coupled between the second antenna 102 and the first division module 109. The first radiation signal S1 received by the first antenna 101 can be transmitted to the first division module 109 through the first coupling circuit 112. The second radiation signal S2 received by the second antenna 102 can be transmitted to the first division module 109 through the second coupling circuit 113.

In some embodiments, the antenna system 10 may be provided as a high-gain antenna. The antenna system 10 comprises a power divider 123. The input ends of the power divider 123 are coupled to the first coupling circuit 112 and the second coupling circuit 113, respectively. The first coupling circuit 112 and the second coupling circuit 113 respectively transmit the first radiation signal S1 and the second radiation signal S2 to the power divider 123 for power combination, i.e., the first coupling circuit 112 transmits the first radiation signal S1 to the power divider 123 and the second coupling circuit 113 transmits the second radiation signal S2 to the power divider 123. And then, the output signal (i.e., the combined signal of the first radiation signal S1 and the second radiation signal S2) is transmitted to a post circuit (not shown). In one embodiment, the power divider 123 may be a 2-way power divider.

In some embodiments, the first coupling circuit 112 and the second coupling circuit 113 may be implemented by a single coupler or by several couplers.

In some embodiments, the first delay line 107 and the second delay line 108 may be made of conductive materials (e.g., but not limited to, copper, silver, iron, alumina, or alloys of two or more of the aforementioned metals). Therefore, the electric path among the first antenna 101, the second antenna 102, and the first division module 109 can be increased. The first delay line 107 delays the first radiation signal S1 for a period of time by the electric path to generate the first delay signal D1. The second delay line 108 delays the second radiation signal S2 for a period of time by the electric path to generate the second delay signal D2. Alternatively, in some embodiments, the first delay line 107 and the second delay line 108 may be implemented by several flip-flops which are series-connected with each other in a sequential manner. A phase difference is between the first delay signal D1 and the first radiation signal S1. A phase difference is between the second delay signal D2 and the second radiation signal S2.

The first division module 109 has two input ends. One of the two input ends of the first division module 109 optionally receives the first radiation signal S1 and the first delay signal D1, and the other input end of the first division module 109 optionally receives the second radiation signal S2 and the second delay signal D2. For example, the first division module 109 combines the first delay signal D1 with the second radiation signal S2 to obtain a first combined signal C1, and the first division module 109 combines the first radiation signal S1 with the second delay signal D2 to obtain a second combined signal C2. After the first division module 109 outputs the first combined signal C1 and the second combined signal C2, based on the first combined signal C1 and the second combined signal C2, the control module 111 determines the incidence direction of the radiofrequency signal sent by the communication target, and the control module 111 controls the rotating mechanism 106 to rotate the substrate 105 clockwise (i.e., the solid line shown in FIG. 2 in which the first side 105A is rotated toward the second side 105B) or counterclockwise (i.e., the dashed line shown in FIG. 2 in which the second side 105B is rotated toward the first side 105A).

In FIG. 1, the first antenna 101 and the second antenna 102 are flatly disposed on the substrate 105 (i.e., the normal direction L1 of the first antenna 101 and that of the second antenna 102 are perpendicular to the horizontal plane of the ground), but embodiments are not limited thereto. Alternatively, the first antenna 101 and the second antenna 102 may be uprightly disposed on the substrate 105 (i.e., the normal direction L1 of the first antenna 101 and that of the second antenna 102 are parallel to the horizontal plane of the ground). In a further alternative, the first antenna 101 and the second antenna 102 may be disposed on the substrate 105 by any orientation, and the normal direction L1 of the first antenna 101 and that of the second antenna 102 create acute or obtuse angle respectively with the horizontal plane of the ground.

Specifically, the antenna system 10 further comprises a first switch SW1 and a second switch SW2. The first switch SW1 is coupled between the first antenna 101 and the first delay line 107, and the first switch SW1 is coupled between the first antenna 101 and the first division module 109. The second switch SW2 is coupled between the second antenna 102 and the second delay line 108, and the second switch SW2 is coupled between the second antenna 102 and the first division module 109.

The first switch SW1 has a first shunt and a second shunt so as to change the signal transmission path between the first antenna 101 and the first division module 109. When the first switch SW1 is switched to the first shunt, the first radiation signal S1 bypasses the first delay line 107 to be directly transmitted to the first division module 109. When the first switch SW1 is switched to the second shunt, the first delay line 107 is electrically connected to the first antenna 101, and the first division module 109 can receive the first delay signal D1 output from the first delay line 107.

Similarly, the second switch SW2 has a first shunt and a second shunt so as to change the signal transmission path between the second antenna 102 and the first division module 109. When the second switch SW2 is switched to the second shunt, the second radiation signal S2 bypasses the second delay line 108 to be directly transmitted to the first division module 109. When the second switch SW2 is switched to the first shunt, the second delay line 108 is electrically connected to the second antenna 102, and the first division module 109 can receive the second delay signal D2 output from the second delay line 108.

Accordingly, the first switch SW1 and the second switch SW2 may be switched to the first shunt to enable the first division module 109 to generate the second combined signal C2, or the first switch SW1 and the second switch SW2 may be switched to the second shunt to enable the first division module 109 to generate the first combined signal C1. In some embodiments, the first switch SW1 and the second switch SW2 may be implemented by single port double throw (SPDT) switches.

The input end of the power detecting module 110 is coupled to the output end of the first division module 109 to receive the first combined signal C1 or the second combined signal C2. In detail, when the first switch SW1 and the second switch SW2 are switched to the second shunt, the power detecting module 110 receives the first combined signal C1. When the first switch SW1 and the second switch SW2 are switched to the first shunt, the power detecting module 110 receives the second combined signal C2. The power detecting module 110 is provided to detect the power of the first combined signal C1 to output a first amplitude P1 and the power of the second combined signal C2 to output a second amplitude P2. The first amplitude P1 represents the amplitude of the direct current voltage of the first combined signal C1. The second amplitude P2 represents the amplitude of the direct current voltage of the second combined signal C2.

In some embodiments, the first division module 109 comprises a power divider. When the first switch SW1 and the second switch SW2 are switched from the second shunt to the first shunt, the first division module 109 sequentially outputs the first combined signal C1 and the second combined signal C2, and the power detecting module 110 sequentially receives the first combined signal C1 and the second combined signal C2 to output the first amplitude P1 and the second amplitude P2.

The input end of the control module 111 is coupled to the output end of the power detecting module 110. The control module 111 sequentially receives the first amplitude P1 and the second amplitude P2. The control module 111 controls the rotating mechanism 106 to rotate the normal direction L1 of the substrate 105 to substantially aim at the communication target.

FIG. 4 illustrates a circuit block diagram of an embodiment of the power detecting module 110 and the control module 111 shown in FIG. 3. Please refer to FIG. 4. The control module 111 comprises a third switch SW3, a register 1111, and a comparator 1112. The third switch SW3 is connected to the power detecting module 110. The register 1111 is connected between the third switch SW3 and the comparator 1112. The comparator 1112 comprises two input ends (i.e., a first input end T1 and a second input end T2). The first input end T1 of the comparator 1112 is connected to the output end of the register 1111, and the second input end T2 of the comparator 1112 is connected to the third switch SW3. The third switch SW3 has a first shunt and a second shunt. The third switch SW3 may be switched between the first shunt and the second shunt and is configured to change the signal transmission path between the power detecting module 110 and the comparator 1112. For example, when the third switch SW3 is switched to the first shunt, the output end of the power detecting module 110 is electrically connected to the input end of the register 1111. When the third switch SW3 is switched to the second shunt, the output end of the power detecting module 110 is electrically connected to the second input end T2 of the comparator 1112.

In the case of the first amplitude P1 is generated firstly followed by the generation of the second amplitude P2, the third switch SW3 is firstly switched to the first shunt so as to store the first amplitude P1 in the register 1111. And then, the third switch SW3 is switched from the first shunt to the second shunt. Hence, after the second amplitude P2 is generated, based on the output of the resister 1111, the comparator 1112 compares the first amplitude P1 with the second amplitude P2 to generate a control signal S5. The control signal S5 may represent that the first amplitude P1 is greater than, equal to, or less than the second amplitude P2.

Where the first amplitude P1 is greater than the second amplitude P2, the communication target is closer to the incidence direction of the first radiation signal S1. Therefore, through the control signal S5, the rotating mechanism 106 rotates the normal direction L1 of the substrate 105 toward the incidence direction of the first radiation signal S1. That is, the rotating mechanism 106 rotates the substrate 105 counterclockwise (as the dashed line shown in FIG. 2). Where the first amplitude P1 is less than the second amplitude P2, the communication target is closer to the incidence direction of the second radiation signal S2. Therefore, through the control signal S5, the rotating mechanism 106 rotates the normal direction L1 of the substrate 105 toward the incidence direction of the second radiation signal S2. That is, the rotating mechanism 106 rotates the substrate 105 clockwise (as the solid line shown in FIG. 2). Where the first amplitude P1 is substantially equal to the second amplitude P2, the substrate 105 is substantially aimed at the communication target. Therefore, the rotating mechanism 106 stops the rotation of the substrate 105 or does not rotate the substrate 105. Accordingly, the first antenna 101 and the second antenna 102 can repeatedly receive the first radiation signal S1 and the second radiation signal S2 so as to generate the control signal S5 repeatedly, and based on the control signal S5, the rotating mechanism 106 rotates the substrate 105 repeatedly until the first antenna 101 and the second antenna 102 are aimed at the communication target.

In some embodiments, the antenna system 10 further comprises a switch control circuit (not shown). The switch control circuit controls the first switch SW1, the second switch SW2, and the third switch SW3 of the control module 111 to be switched to the first shunt. And then, after the register 1111 stores the second combined signal C2, the switch control circuit controls the first switch SW1, the second switch SW2, and the third switch SW3 of the control module 111 to be switched from the first shunt to the second shunt. Alternatively, the switch control circuit may control the first switch SW1 and the second switch SW2 to be switched to the second shunt and control the third switch SW3 of the control module 111 to be switched to the first shunt. And then, after the register 1111 stores the first combined signal C1, the switch control circuit controls the first switch SW1 and the second switch SW2 to be switched from the second shunt to the first shunt and controls the third switch SW3 of the control module 111 to be switched from the first shunt to the second shunt. The rotating mechanism 106 may rotate the substrate 105 based on the control signal S5.

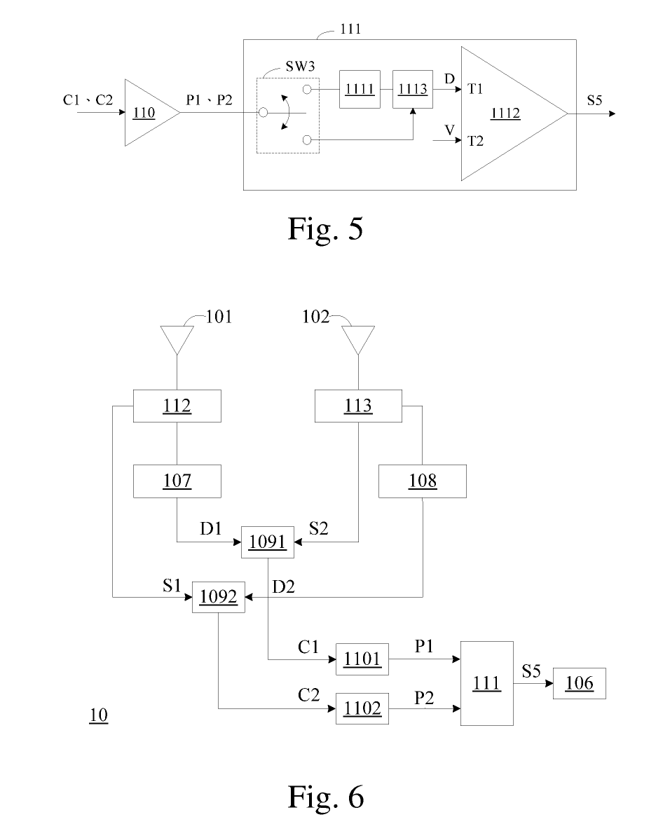

FIG. 5 illustrates a circuit block diagram of another embodiment of a control module 111 shown in FIG. 3. Please refer to FIG. 5. The difference between FIG. 4 and FIG. 5 is in that the control module 111 comprises a subtractor 1113. One of two ends of the subtractor 1113 is electrically connected to the output end of the register 1111, and the other end of the subtractor 1113 is electrically connected to the third switch SW3. The first input end T1 of the comparator 1112 is coupled to the output end of the subtractor 1113, and the second input end T2 of the comparator 1112 is provided to input a voltage signal V. Based on the switching of the third switch SW3, the subtractor 1113 obtains a difference between the second amplitude P2 and the first amplitude P1 so as to output a difference value D. The comparator 1112 receives the difference value D and compares the difference value D with the voltage signal V so as to output the control signal S5. In some embodiments, the voltage signal V is a direct current voltage, and the magnitude of the voltage signal V can be provided as a threshold value. For example, the voltage signal V may be zero volts, and the comparator 1112 determines whether the difference value D is substantially zero volts or not so as to determine whether the first amplitude P1 is greater than, equal to, or less than the second amplitude P2.

FIG. 6 illustrates a circuit diagram of the second embodiment of the antenna system 10 of FIGS. 1 and 2. Please refer to FIG. 3 and FIG. 6, in some embodiments, the first division module 109 comprises a divider, and the power detecting module 110 comprises a power detector, but embodiments are not limited thereto. As shown in FIG. 6, in some embodiments, the first division module 109 may comprise two dividers (a first divider 1091 and a second divider 1092), and the power detecting module 110 may comprise two power detectors (for convenience, called a first power detector 1101 and a second power detector 110). The first divider 1091 is series-connected to the first power detector 1101. The second divider 1092 is series-connected to the second power detector 1102, the second divider 1092 outputs the second combined signal C2, and the second power detector 1102 generates the second amplitude P2 based on the second combined signal C2. In this embodiment, if the first antenna 101 and the second antenna 102 substantially simultaneously receive the first radiation signal S1 and the second radiation signal S2, the power detecting module 110 may substantially simultaneously generate the first amplitude P1 and the second amplitude P2.

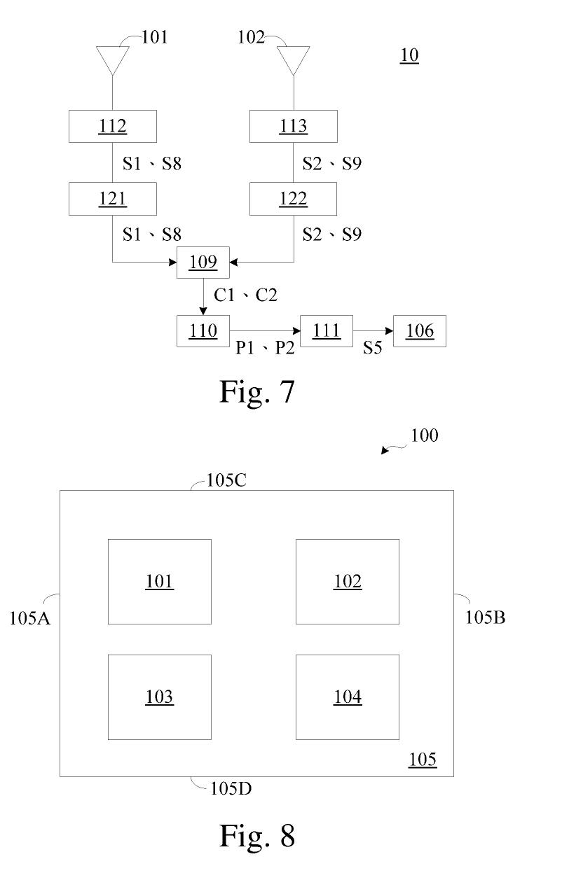

FIG. 7 illustrates a circuit block diagram of the third embodiment of the antenna system 10 of FIGS. 1 and 2. Please refer to FIG. 7, in some embodiments, the antenna system 10 comprises a first storage unit 121 and a second storage unit 122. The first antenna 101, the first coupling circuit 112, the first storage unit 121, and the first division module 109 are series-connected sequentially. The second antenna 102, the second coupling circuit 113, the second storage unit 122, and the first division module 109 are series-connected sequentially.

In order to make the rotating mechanism 106 rotate the substrate 105, the first antenna 101 receives the first radiation signal S1 at a first point of time and receives a fifth radiation signal S8 at a third point of time sequentially, and the second antenna 102 receives the second radiation signal S2 at a second point of time and receives a sixth radiation signal S9 at a fourth point of time sequentially. After both the first radiation signal S1 and the fifth radiation signal S8 are stored in the first storage unit 121 and both the second radiation signal S2 and the sixth radiation signal S9 are stored in the second storage unit 122, the first storage unit 121 and the second storage unit 122 respectively output the first radiation signal S1 and the sixth radiation signal S9, and the first storage unit 121 and the second storage unit 112 respectively output the second radiation signal S2 and the fifth radiation signal S8, so that the first division module 109 combines the first radiation signal S1 and the sixth radiation signal S9 to be the first combined signal C1 and combines the second radiation signal S2 and the fifth radiation signal S9 to be the second combined signal C2. Accordingly, based on the comparison result between the first amplitude P1 and the second amplitude P2 (i.e., a result whether the first amplitude P1 is greater than, equal to, or less than the second amplitude P2), the control module 111 drives the rotating mechanism 106 to rotate the substrate 105.

In some embodiments, the first division module 109 may comprise one or two dividers. In the case of the first storage unit 121 and the second storage unit 112 respectively output the first radiation signal S1 and the sixth radiation signal S9, the first division module 109 sequentially generates the first combined signal C1 and the second combined signal C2 if the number of the divider is one, while the first division module 109 can generate the first combined signal C1 and the second combined signal C2 simultaneously if the number of the divider is two.

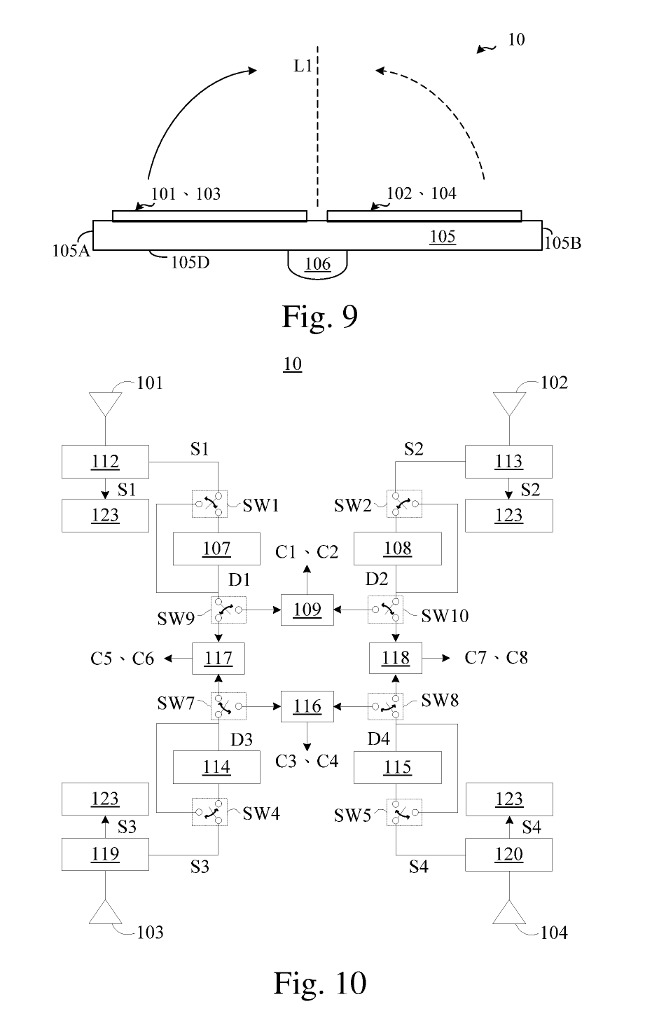

FIG. 8 and FIG. 9 illustrate respectively a top view and a side view of an antenna system 10 having an automatically adjustable directional antenna structure 100 according to a second embodiment of the instant disclosure. Please refer to FIG. 1, FIG. 8, and FIG. 9, the antenna system 10 of the second embodiment is approximately similar to that of the first embodiment, except that in the second embodiment, the directional antenna structure 100 of the antenna system 10 further comprises a third antenna 103 and a fourth antenna 104. The third antenna 103 and the fourth antenna 104 are also assembled on the first surface of the substrate 105. The first antenna 101, the second antenna 102, the third antenna 103, and the fourth antenna 104 are collectively formed as a rectangular array on the substrate 105. When the normal direction L1 of the substrate 105 is changed along with the rotation of the rotating mechanism 106, the first antenna 101, the second antenna 102, the third antenna 103, and the fourth antenna 104 are also rotated to aim at the communication target.

In some embodiments, the substrate 105 has a first side 105A, a second side 105B, a third side 105C, and a fourth side 105D. The first antenna 101 and the third antenna 103 are configured along the first side 105A of the substrate 105. The second antenna 102 and the fourth antenna 104 are configured along the second side 105B of the substrate 105. The first antenna 101 and the second antenna 102 are configured along the third side 105C of the substrate 105. The third antenna 103 and the fourth antenna 104 are configured along the fourth side 105D of the substrate 105.

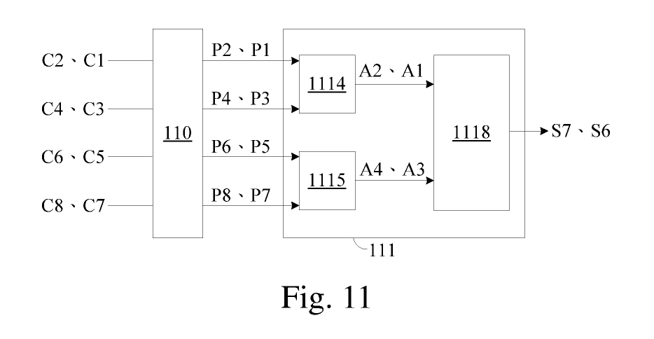

FIG. 10 illustrates a circuit block diagram of one embodiment of the antenna system 10 of FIG. 8 and FIG. 9. FIG. 11 illustrates a circuit block diagram of an embodiment of the power detecting module 110 and the control module 111 of the second embodiment of the antenna system 10. Please refer to FIG. 3, FIG. 10, and FIG. 11, as compared with the antenna system 10 in FIG. 3, the antenna system 10 in FIG. 11 further comprises the third antenna 103, the fourth antenna 104, a third delay line 114, a fourth delay line 115, and a second division module 116. In FIG. 10, the substrate 105 is not shown. The third delay line 114 is coupled between the third antenna 103 and the second division module 116. The fourth delay line 115 is coupled between the fourth antenna 104 and the second division module 116.

The third antenna 103 receives a third radiation signal S3. The third delay line 114 is coupled to the third antenna 103 so as to delay the third radiation signal S3 to obtain a third delay signal D3. The fourth antenna 104 receives a fourth radiation signal S4. The fourth delay line 115 is coupled to the fourth antenna 104 so as to delay the fourth radiation signal S4 to obtain a fourth delay signal D4.

The second division module 116 has two input ends. One of the two input ends of the second division module 116 optionally receives the third delay signal D3 and the fourth radiation signal S4, and the other input end of the second division module 116 optionally receives the third radiation signal S3 and the fourth delay signal D4. The second division module 116 combines the third delay signal D3 with the fourth radiation signal S4 to obtain a third combined signal C3, and the second division module 116 combines the third radiation signal S3 with the fourth delay signal D4 to obtain a fourth combined signal C4.

In some embodiments, the antenna system 10 further comprises a third coupling circuit 119 and a fourth coupling circuit 120. The third coupling circuit 119 is coupled between the third antenna 103 and the third delay line 114, and the third coupling circuit 119 is coupled between the third antenna 103 and the second division module 116. The fourth coupling circuit 120 is coupled between the fourth antenna 104 and the fourth delay line 115, and the fourth coupling circuit 120 is coupled between the fourth antenna 104 and the second division module 116. The fourth coupling circuit 120 transmits the fourth radiation signal S4 received by the fourth antenna 104 to the second division module 116. The third coupling circuit 119 transmits the third radiation signal S3 received by the third antenna 103 to the second division module 116.

In some embodiments, the antenna system 10 may be provided as a high-gain antenna. The antenna system 10 comprises a power divider 123. The input ends of the power divider 123 are coupled to the first coupling circuit 112, the second coupling circuit 113, the third coupling circuit 119, and the fourth coupling circuit 120, respectively. The first radiation signal S1, the second radiation signal S2, the third radiation signal S3, and the fourth radiation signal S4 are transmitted to the power divider 123 for power combination and output to a post circuit (not shown) via the first coupling circuit 112, the second coupling circuit 113, the third coupling circuit 119, and the fourth coupling circuit 120 respectively. The power divider 123 may be a 4-way power divider.

In some embodiments, the third coupling circuit 119 and the fourth coupling circuit 120 may be implemented by a single coupler or by several couplers.

The antenna system 10 further comprises a fourth switch SW4 and a fifth switch SW5. The fourth switch SW4 is coupled between the third antenna 103 and the third delay line 114, and the fourth switch SW4 is coupled between the third antenna 103 and the second division module 116. The fifth switch SW5 is coupled between the fourth antenna 104 and the fourth delay line 115, and the fifth switch SW5 is coupled between the fourth antenna 104 and the second division module 116.

The fourth switch SW4 has a first shunt and a second shunt so as to change the signal transmission path between the third antenna 103 and the second division module 116. The fifth switch SW5 has a first shunt and a second shunt so as to change the signal transmission path between the fourth antenna 104 and the second division module 116. When the fourth switch SW4 and the fifth switch SW5 are switched to the first shunt, the second division module 116 outputs the fourth combined signal C4. When the fourth switch SW4 and the fifth switch SW5 are switched to the second shunt, the second division module 116 outputs the third combined signal C3.

Accordingly, when the switches SW1, SW2, SW4, SW5 are all switched to the second shunt, the first division module 109 and the second division module 116 respectively output the first combined signal C1 and the third combined signal C3 so as to generate delayed signal components respectively including the first radiation signal S1 and the third radiation signal S3. When the switches SW1, SW2, SW4, SW5 are all switched to the first shunt, the first division module 109 and the second division module 116 respectively output the second combined signal C2 and the fourth combined signal C4 so as to generate delayed signal components respectively including the second radiation signal S2 and the fourth radiation signal S4. Based on the first combined signal C1, the second combined signal C2, the third combined signal C3, and the fourth combined signal C4, the control module 111 determines whether the communication target is close to the first antenna 101 and the third antenna 103 or close to the second antenna 102 and the fourth antenna 104.

If the communication target is close to the first antenna 101 and the third antenna 103, the rotating mechanism 106 controls the substrate 105 to rotate counterclockwise (as the dashed line shown in FIG. 9 in which the second side 105B is rotated toward the first side 105A). While if the communication target is close to the second antenna 102 and the fourth antenna 104, the rotating mechanism 106 controls the substrate 105 to rotate clockwise (as the solid line shown in FIG. 9 in which the first side 105A is rotated toward the second side 105B).

The antenna system 10 further comprises a third division module 117 and a fourth division module 118. The third division module 117 is coupled between the first delay line 107 and the third delay line 114. When the first switch SW1 is switched to the first shunt and the fourth switch SW4 is switched to the second shunt, the third division module 117 combines the first radiation signal S1 with the third delay signal D3 to obtain a fifth combined signal C5. When the first switch SW1 is switched to the second shunt and the fourth switch SW4 is switched to the first shunt, the third division module 117 combines the first delay signal D1 with the third radiation signal S3 to obtain a sixth combined signal C6.

The fourth division module 118 is coupled between the second delay line 108 and the fourth delay line 115. When the second switch SW2 is switched to the second shunt and the fifth switch SW5 is switched to the first shunt, the fourth division module 118 combines the second radiation signal S2 with the fourth delay signal D4 to obtain a seventh combined signal C7. When the second switch SW2 is switched to the first shunt and the fifth switch SW5 is switched to the second shunt, the fourth division module 118 combines the second delay signal D2 with the fourth radiation signal S4 to obtain an eighth combined signal C8.

Based on the fifth combined signal C5, the seventh combined signal C7, the sixth combined signal C6, and the eighth combined signal C8, the control module 111 determines whether the communication target is close to the first antenna 101 and the second antenna 102 or close to the third antenna 103 and the fourth antenna 104. Specifically, if the communication target is close to the first antenna 101 and the second antenna 102, the control module 111 controls the rotating mechanism 106 to rotate the fourth side 105D toward the third side 105C. While if the communication target is close to the third antenna 103 and the fourth antenna 104, the control module 111 controls the rotating mechanism 106 to rotate the third side 105C toward the fourth side 105D.

The antenna system 10 further comprises switches SW7, SW8, SW9, SW10. Each of the switches SW7, SW8, SW9, SW10 has a first shunt and a second shunt. When the switches SW7, SW8, SW9, SW10 are switched to the first shunt, the first division module 109 is electrically connected to the first antenna 101 and the second antenna 102, the second division module 116 is electrically connected to the third antenna 103 and the fourth antenna 104, and the third division module 117 and the fourth division module 118 are disconnected to each of the antennas 101, 102, 103, 104. Therefore, the rotating mechanism 106 may rotate the substrate 105 to rotate the normal direction L1 of the substrate 105 toward the incidence direction of the first radiation signal S1 and the third radiation signal S3, or to rotate the normal direction L1 of the substrate 105 toward the incidence direction of the second radiation signal S2 and the fourth radiation signal S4.

When the switches SW7, SW8, SW9, SW10 are switched to the second shunt, the first division module 109 and the second division module 116 are disconnected to each of the antennas 101, 102, 103, 104, the third division module 117 is electrically connected to the first antenna 101 and the third antenna 103, and the fourth division module 118 is electrically connected to the second antenna 102 and the fourth antenna 104. Therefore, the rotating mechanism 106 may rotate the substrate 105 to rotate the normal direction L1 of the substrate 105 toward the incidence direction of the first radiation signal S1 and the second radiation signal S2, or to rotate the normal direction L1 of the substrate 105 toward the incidence direction of the third radiation signal S3 and the fourth radiation signal S4.

As shown in FIG. 11, the power detecting module 110 respectively detects the first combined signal C1, the second combined signal C2, the third combined signal C3, the fourth combined signal C4, the fifth combined signal C5, the sixth combined signal C6, the seventh combined signal C7, and the eighth combined signal C8 so as to generate the first amplitude P1, the second amplitude P2, a third amplitude P3, a fourth amplitude P4, a fifth amplitude P5, a sixth amplitude P6, a seventh amplitude P7, and an eighth amplitude P8. In some preferred embodiment, the power detecting module 110 may comprise four power detectors.

The control module 111 comprises a first adding circuit 1114, a second adding circuit 1115, and a control unit 1118. The input end of the first adding circuit 1114 is coupled to the output end of the power detecting module 110. The first adding circuit 1114 receives the third amplitude P3 and the first amplitude P1 and adds the third amplitude P3 and the first amplitude P1 to output a first added amplitude A1. Besides, the first adding circuit 1114 receives the fourth amplitude P4 and the second amplitude P2 and adds the fourth amplitude P4 and the second amplitude P2 to output a second added amplitude A2. The input end of the second adding circuit 1115 is coupled to the output end of the power detecting module 110. The second adding circuit 1115 receives the fifth amplitude P5 and the seventh amplitude P7 and adds the fifth amplitude P5 and the seventh amplitude P7 to output a third added amplitude A3. Further, the second adding circuit 1115 receives the sixth amplitude P6 and the eighth amplitude P8 and adds the sixth amplitude P6 and the eighth amplitude P8 to output a fourth added amplitude A4.

In some embodiments, the first adding circuit 1114 and the second adding circuit 1115 may be implemented by one adder or more adders.

The control unit 1118 has two input ends respectively connected to the output end of the first adding circuit 1114 and the output end of the second adding circuit 1115. The control unit 1118 receives the first added amplitude A1 and the second added amplitude A2 and generates the control signal S5 to the rotating mechanism 106 based on the first added amplitude A1 and the second added amplitude A2. Besides, the control unit 1118 receives the third added amplitude A3 and the fourth added amplitude A4 and generates the control signal S5 to the rotating mechanism 106 based on the third added amplitude A3 and the fourth added amplitudes A4. The control signal S5 comprises a first control signal S6 and a second control signal S7. Based on the first control signal S6, the rotating mechanism 106 may rotate the normal direction L1 of the substrate 105 toward the incidence direction of the first radiation signal S1 and the third radiation signal S3. Alternatively, based on the second control signal S7, the rotating mechanism 106 may rotate the normal direction L1 of the substrate 105 toward the incidence direction of the third radiation signal S3 and the fourth radiation signal S4.

If the first added amplitude A1 is greater than the second added amplitude A2, based on the first control signal S6, the rotating mechanism 106 rotates the normal direction L1 of the substrate 105 toward the incidence direction of the first radiation signal S1 and the third radiation signal S3. If the first added amplitude A1 is less than the second added amplitude A2, the rotating mechanism 106 rotates the normal direction L1 of the substrate 105 toward the incidence direction of the second radiation signal S2 and the fourth radiation signal S4 based on the first control signal S6. If the first added amplitude A1 is equal to the second added amplitude A2, the rotating mechanism 106 stops rotating the substrate 105 or does not rotate the substrate 105.

Similarly, if the third added amplitude A3 is greater than the fourth added amplitude A4, based on the second control signal S7, the rotating mechanism 106 rotates the normal direction L1 of the substrate 105 toward the incidence direction of the third radiation signal S3 and the fourth radiation signal S4. If the third added amplitude A3 is less than the fourth added amplitude A4, based on the second control signal S7, the rotating mechanism 106 rotates the normal direction L1 of the substrate 105 toward the incidence direction of the first radiation signal S1 and the second radiation signal S2. If the third added amplitude A3 is equal to the fourth added amplitude A4, the rotating mechanism 106 stops the rotation of the substrate 105 or does not rotate the substrate 105.

Based on the first control signal S6 and the second control signal S7, the rotating mechanism 106 repeatedly adjusts the substrate 105 until the first antenna 101, the second antenna 102, the third antenna 103, and the fourth antenna 104 are aimed at the communication target.

In some embodiments, the control unit 1118 may obtain a difference between the second added amplitude A2 and the first added amplitude A1 to generate a first difference value, and compare the first difference value with a threshold value whose magnitude is zero volts, so that the control unit can determine if the substrate is aimed at the communication target or not. In addition, the control unit 1118 may also obtain a difference between the fourth added amplitude and the third added amplitude to generate a second difference value and compare the second difference value with a threshold value whose magnitude is zero volts, so that the control unit can determine if the substrate is aimed at the communication target or not.

For example, in the case of the communication target is closed to the first antenna 101 and the third antenna 103 and closed to the first antenna 101 and the second antenna 102, following procedures are carried out, for example but not limited to. Firstly, the first radiation signal S1 and the third radiation signal S3 are delayed while the second radiation signal S2 and the fourth radiation signal S4 are not delayed, the switches SW1, SW2, SW4, SW5 are switched to the second shunt, the switches SW7, SW8, SW9, SW10 are switched to the first shunt, the power detecting module 110 detects the first amplitude P1 of the first combined signal C1 and the second amplitude P2 of the second combined signal C2 both having a value of −44.72 dBm, and the value of the first added amplitude A1 generated by the first adding circuit 1114 is 1165 mV.

Next, the first radiation signal S1 and the third radiation signal S3 are not delayed while the second radiation signal S2 and the fourth radiation signal S4 are delayed, the switches SW1, SW2, SW4, SW5 are switched from the second shunt to the first shunt, the power detecting module 110 detects the second amplitude P2 of the second combined signal C2 and the fourth amplitude P4 of the fourth combined signal C4 both having a value of −51.01 dBm, and the value of the second added amplitude A2 generated by the first adding circuit 1114 is 980 mV. Accordingly, the control unit 1118 generates a difference value of 185 mV which is greater than zero volts after subtracting the second added amplitude A2 from the first added amplitude A1, and thus the rotating mechanism 106 rotates the substrate 105 counterclockwise (as the dashed line shown in FIG. 9 in which the second side 105B is rotated toward the first side 105A).

Next, the first radiation signal S1 and the second radiation signal S2 are delayed while the third radiation signal S3 and the fourth radiation signal S4 are not delayed, the switches SW1, SW5, SW7, SW8, SW9, SW10 are switched to the second shunts, the power detecting module 110 detects the sixth amplitude P6 of the sixth combined signal C6 and the eighth amplitude P8 of the eighth combined signal C8 both having a value of −44.72 dBm, and the value of the fourth added amplitude A4 generated by the second adding circuit 1115 is 1165 mV.

Next, the first radiation signal S1 and the second radiation signal S2 are not delayed while the third radiation signal S3 and the fourth radiation signal S4 are delayed, the switches SW1, SW5 are switched to the first shunts, the switches SW2, SW4 are switched to the second shunts, the power detecting module 110 detects the fifth amplitude P5 of the fifth combined signal C5 and the seventh amplitude P7 of the seventh combined signal C7 both having a value of −51.01 dBm, and the value of the third added amplitude A3 generated by the second adding circuit 1115 is 980 mV. Accordingly, the control unit 1118 generates a difference value of 185 mV which is greater than zero volts after subtracting the third added amplitude A3 from the fourth added amplitude A4—and thus the rotating mechanism 106 rotates the substrate 105 from the fourth side 105D toward the third side 105C.

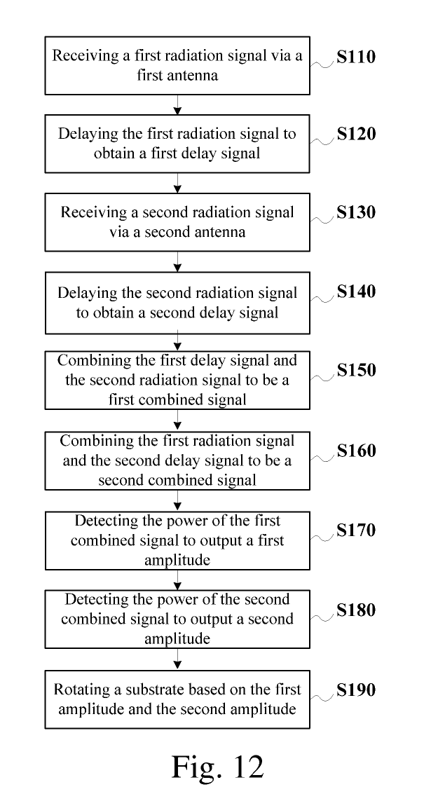

FIG. 12 illustrates a flowchart of a method for automatically adjusting a directional antenna structure according to a third embodiment of the instant disclosure. The method comprises receiving the first radiation signal S1 via the first antenna 101 (step S110), utilizing the first delay line 107 to delay the first radiation signal S1 to obtain the first delay signal D1 (step S120), receiving the second radiation signal S2 via the second antenna 102 (step S130), utilizing the second delay line 108 to delay the second radiation signal S2 to obtain the second delay signal D2 (step S140), utilizing the first division module 109 to combine the first delay signal D1 and the second radiation signal S2 to be the first combined signal C1 (step S150), utilizing the first division module 109 to combine the first radiation signal S1 and the second delay signal D2 to be the second combined signal C2 (step S160), utilizing the power detecting module 110 to detect the power of the first combined signal C1 so as to output the first amplitude P1 (step S170), utilizing the power detecting module 110 to detect the power of the second combined signal C2 so as to output the second amplitude P2 (step S180), and rotating the substrate 105 based on the first amplitude P1 and the second amplitude P2 (step S190). Therefore, the normal direction L1 of the substrate 105 is rotated and aimed at a flying object or aimed at the communication target.

In the step S190, the control module 111 outputs the control signal S5 based on the first amplitude P1 and the second amplitude P2, and the rotating mechanism 106 rotates the substrate 105 based on the control signal S5.

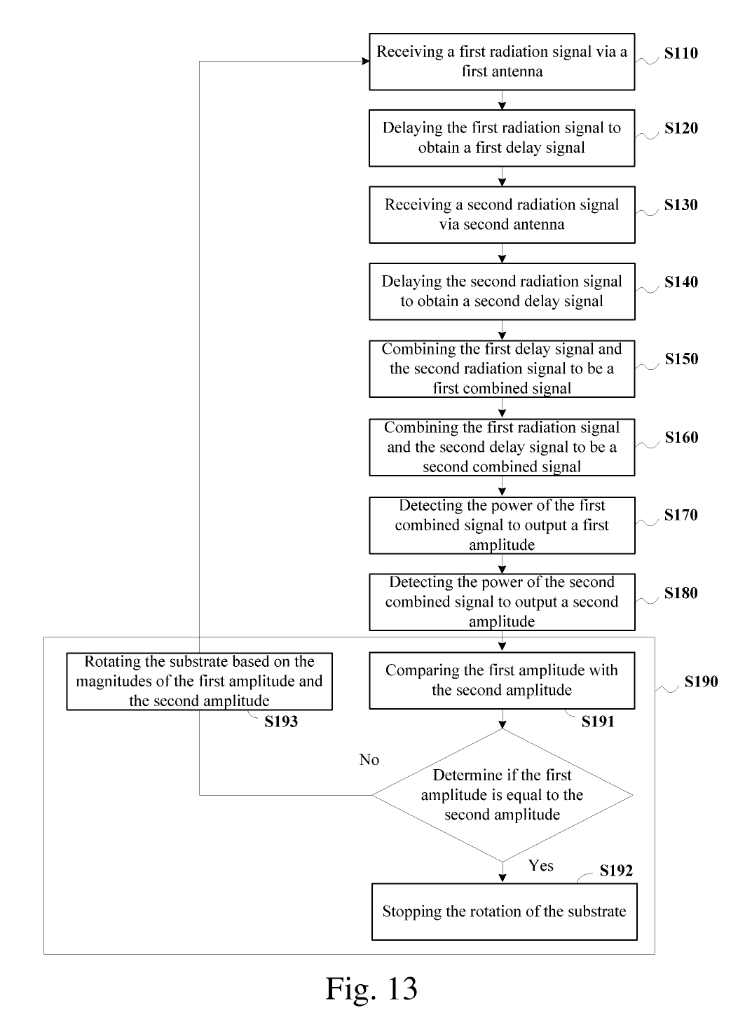

FIG. 13 illustrates a flowchart of an embodiment of the method of the third embodiment. Please refer to FIG. 13, the step S190 further comprises utilizing the control module 111 to compare the first amplitude P1 and the second amplitude P2 (step S191). If the first amplitude P1 is equal to the second amplitude P2, the rotating mechanism 106 stops rotating the substrate 105 (step S192). If the first amplitude P1 is not equal to the second amplitude P2, the rotating mechanism rotates the substrate 105 based on the magnitudes of the first amplitude P1 and the second amplitude P2 (step S193). In detail, when the first amplitude P1 is greater than the second amplitude P2, the rotating mechanism 106 rotates the normal direction L1 of the substrate 105 to rotate toward the incidence direction of the first radiation signal S1; when the first amplitude P1 is less than the second amplitude P2, the rotating mechanism 106 rotates the normal direction L1 of the substrate 105 to rotate toward the incidence direction of the second radiation signal S2.

Another embodiment of step S190 is described as following. In the embodiment the control module 111 may obtain a difference between the first amplitude P1 and the second amplitude P2 to output a difference value and compare the difference value with the threshold value. When the difference value is greater than the threshold value, the normal direction L1 of the substrate 105 is rotated toward the incidence direction of the first radiation signal S1. When the difference value is less than the threshold value, the normal direction L1 of the substrate 105 is rotated toward the incidence direction of the second radiation signal S2. When the difference value is equal to the threshold value, the rotating mechanism 106 stops the rotation of the substrate 105 or does not rotate the substrate 105. Therefore, the substrate 105 can be substantially aimed at the communication target.

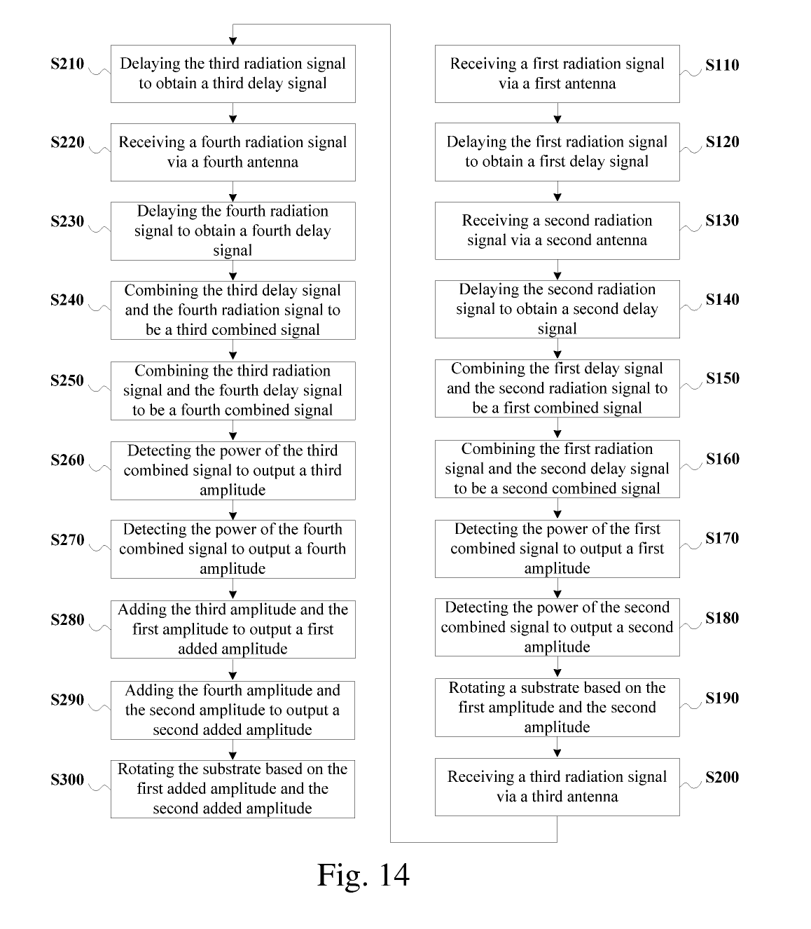

FIG. 14 illustrates a flowchart of a method for automatically adjusting a directional antenna structure according to a fourth embodiment of the instant disclosure. The method further comprises receiving the third radiation signal S3 via the third antenna 103 (step S200), utilizing the third delay line 114 to delay the third radiation signal S3 to obtain the third delay signal D3 (step S210), receiving the fourth radiation signal S4 via the fourth antenna 104 (step S220), utilizing the fourth delay line 115 to delay the fourth radiation signal S4 to obtain the fourth delay signal D4 (step S230), utilizing the second division module 116 to combine the third delay signal D3 and the fourth radiation signal S4 to be the third combined signal C3 (step S240), utilizing the second division module 116 to combine the third radiation signal S3 and the fourth delay signal D4 to be the fourth combined signal C4 (step S250), utilizing the power detecting module 110 to detect the power of the third combined signal C3 so as to output the third amplitude P3 (step S260), utilizing the power detecting module 110 to detect the power of the fourth combined signal C4 so as to output the fourth amplitude P4 (step S270), utilizing the first adding circuit 1114 to add the third amplitude P3 and the first amplitude P1 to output the first added amplitude A1 (step S280), utilizing the first adding circuit 1114 to add the fourth amplitude P4 and the second amplitude P2 to output the second added amplitude A2 (step S290), and utilizing the control module 111 to generate a first control signal S6 based on the first added amplitude A1 and the second added amplitude A2 so as to drive the rotating mechanism 106 to rotate the substrate 105 (step S300). Therefore, the first antenna 101, the second antenna 102, the third antenna 103, and the fourth antenna 104 of the substrate 105 can be substantially aimed at the flying object or the communication target.

Based on the above, the direction of the directional antenna structure is adjusted by the control module of the antenna system, so that the directional antenna structure can trace the flying object or the communication target automatically. Because the antenna of the directional antenna structure can be maintained in a workable receiving state, the user does not have to adjust the antenna in a repeated and complicated manner.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A method for automatically adjusting a directional antenna structure, for tracing a flying object, wherein the directional antenna structure comprises a substrate, a first antenna, and a second antenna, the first antenna and the second antenna are assembled on the substrate, wherein the method comprises:
receiving a first radiation signal via the first antenna;
delaying the first radiation signal to obtain a first delay signal;
receiving a second radiation signal via the second antenna;
delaying the second radiation signal to obtain a second delay signal;
combining the first delay signal and the second radiation signal to obtain a first combined signal;
combining the first radiation signal and the second delay signal to obtain a second combined signal;
detecting the power of the first combined signal to output a first amplitude;
detecting the power of the second combined signal to output a second amplitude; and
rotating the substrate based on the first amplitude and the second amplitude, so that a normal direction of the substrate is rotated and substantially aimed at the object.

2. The method according to claim 1, wherein the step of “rotating the substrate based on the first amplitude and the second amplitude” comprises:
outputting a control signal based on the first amplitude and the second amplitude; and
driving a rotating mechanism based on the control signal so as to rotate the substrate.

3. The method according to claim 1, wherein the step of “rotating the substrate based on the first amplitude and the second amplitude” comprises:
comparing the first amplitude with the second amplitude;
wherein the normal direction of the substrate is rotated toward the incidence direction of the first radiation signal when the first amplitude is greater than the second amplitude;
the normal direction of the substrate is rotated toward the incidence direction of the second radiation signal when the first amplitude is less than the second amplitude; and the substrate is stopped rotating when the first amplitude is equal to the second amplitude.

4. The method according to claim 1, wherein the step of “rotating the substrate based on the first amplitude and the second amplitude” comprises:
obtaining a difference between the second amplitude and the first amplitude to output a difference value;
comparing the difference value with a threshold value;
wherein the normal direction of the substrate is rotated toward the incidence direction of the first radiation signal when the difference value is greater than the threshold value; the normal direction of the substrate is rotated toward the incidence direction of the second radiation signal when the difference value is less than the threshold value; and the substrate is stopped rotating when the difference value is equal to the threshold value.

5. The method according to claim 1, wherein the directional antenna structure further comprises a third antenna and a fourth antenna, and the first antenna, the second antenna, the third antenna, and the fourth antenna are collectively formed as a rectangular array on the substrate, and the method further comprises:
receiving a third radiation signal via the third antenna;
delaying the third radiation signal to obtain a third delay signal;
receiving a fourth radiation signal via the fourth antenna;
delaying the fourth radiation signal to obtain a fourth delay signal;
combining the third delay signal and the fourth radiation signal to obtain a third combined signal;
combining the third radiation signal and the fourth delay signal to obtain a fourth combined signal;
detecting the power of the third combined signal to output a third amplitude; and
detecting the power of the fourth combined signal to output a fourth amplitude.

6. The method according to claim 5, further comprising:
adding the third amplitude and the first amplitude to output a first added amplitude;
adding the fourth amplitude and the second amplitude to output a second added amplitude; and
rotating the substrate based on the first added amplitude and the second added amplitude.

7. An antenna system having an automatically adjustable directional antenna structure, wherein the system is adapted for tracing a flying object, and the system comprises:
a substrate;
a first antenna for receiving a first radiation signal;
a second antenna for receiving a second radiation signal, wherein the first antenna and the second antenna are assembled on the substrate;
a rotating mechanism coupled to the substrate;
a first delay line coupled to the first antenna and for delaying the first radiation signal to obtain a first delay signal;
a second delay line coupled to the second antenna and for delaying the second radiation signal to obtain a second delay signal;
a first division module for combining the first delay signal and the second radiation signal to obtain a first combined signal and combining the first radiation signal and the second delay signal to obtain a second combined signal;
a power detecting module for detecting the power of the first combined signal to output a first amplitude and detecting the power of the second combined signal to output a second amplitude; and
a control module coupled to the rotating mechanism and the first division module, wherein the control module is adapted to control the rotating mechanism based on the first amplitude and the second amplitude so as to rotate a normal direction of the substrate to substantially aim at the object.

8. The antenna system according to claim 7, wherein the control module comprises:
a comparator for comparing the first amplitude and the second amplitude to output a control signal;
wherein the normal direction of the substrate is rotated toward the incidence direction of the first radiation signal when the first amplitude is greater than the second amplitude; the normal direction of the substrate is rotated toward the incidence direction of the second radiation signal when the first amplitude is less than the second amplitude; and the substrate is stopped rotating when the first amplitude is equal to the second amplitude.

9. The antenna system according to claim 7, wherein the control module comprises:
a subtractor for obtaining a difference between the second amplitude and the first amplitude to output a difference value; and
a comparator for comparing the difference value with a threshold value to output a control signal;
wherein the normal direction of the substrate is rotated toward the incidence direction of the first radiation signal when the first amplitude is greater than the second amplitude; the normal direction of the substrate is rotated toward the incidence direction of the second radiation signal when the first amplitude is less than the second amplitude; and the substrate is stopped rotating when the first amplitude is equal to the second amplitude.

10. The antenna system according to claim 7, further comprising:
a third antenna for receiving a third radiation signal;
a fourth antenna for receiving a fourth radiation signal, wherein the first antenna, the second antenna, the third antenna, and the fourth antenna are collectively formed as a rectangular array on the substrate;
a third delay line coupled to the third antenna and for delaying the third radiation signal to obtain a third delay signal;
a fourth delay line coupled to the fourth antenna and for delaying the fourth radiation signal to obtain a fourth delay signal; and
a second division module for combining the third delay signal and the fourth radiation signal to obtain a third combined signal and for combining the third radiation signal and the fourth delay signal to obtain a fourth combined signal, wherein the power detecting module is further provided for detecting the power of the third combined signal to output a third amplitude and detecting the power of the fourth combined signal to output a fourth amplitude, and the control module comprises:
a first adding circuit for adding the third amplitude and the first amplitude to output a first added amplitude and adding the fourth amplitude and the second amplitude to output a second added amplitude; and
a control unit for generating a control signal to the rotating mechanism based on the first added amplitude and the second added amplitude.

11. The antenna system according to claim 10, further comprising:
a third division module for combining the first radiation signal and the third delay signal to obtain a fifth combined signal and combining the first delay signal and the third radiation signal to obtain a sixth combined signal; and
a fourth division module for combining the second radiation signal and the fourth delay signal to obtain a seventh combined signal, and combining the second delay signal and the fourth radiation signal to obtain an eighth combined signal, wherein the power detecting module is further provided for detecting the power of the fifth combined signal to output a fifth amplitude, detecting the power of the sixth combined signal to output a sixth amplitude, detecting the power of the seventh combined signal to output a seventh amplitude, and detecting the power of the eighth combined signal to output an eighth amplitude, and the control module further comprises:
a second adding circuit for adding the seventh amplitude and the fifth amplitude to output a third added amplitude and adding the eighth amplitude and the sixth amplitude to output a fourth added amplitude; the control unit is further provided for generating another control signal to the rotating mechanism based on the third added amplitude and the fourth added amplitude, and the rotating mechanism rotates the substrate based on the another control signal so that the normal direction of the substrate is rotated and substantially aimed at the object.
